(19) United States
(12) Patent Application Publication
(10) Pub. No.: US 2023/0074262 A1
(43) Pub. Date: Mar. 9, 2023

(54) REUSABLE PAINT CONTAINER

(71) Applicants: Roman Marinov, Chilliwack (CA); Ilan Rublevsky, Chilliwack (CA)

(72) Inventors: Roman Marinov, Chilliwack (CA); Ilan Rublevsky, Chilliwack (CA)

(21) Appl. No.: 17/446,989

(22) Filed: Sep. 7, 2021

(51) Int. Cl. B44D 3/12

(52) U.S. Cl. CPC B44D 3/128

(57) ABSTRACT

A reversible paint container that is configured to be moved between a first position and a second position so as to provide a clean interior volume ensuing an initial use thereof. The present invention includes a body that is annular in shape having a wall and bottom forming an interior volume. The wall and bottom are manufactured from a pliable material such as but not limited to rubber or silicon. The body includes an upper perimeter edge that is circumferentially disposed around the opening of the container. The upper perimeter edge is manufactured from a rigid material such as but not limited to plastic. A brush member is integrally formed in the wall of the body. The wall includes a first surface and a second surface wherein the first surface is facing the interior volume in the first position of the body.

### FIELD OF THE INVENTION

The present invention relates generally to containers, more specifically but not by way of limitation, a container configured to receive paint and be utilized during the painting process wherein the container of the present invention is reversible providing a first position and a second position.

### BACKGROUND

Many types of materials from walls to floors are often coated with paint or other types of coatings depending upon the application. Some coatings are for cosmetic reasons such as paint for walls in homes and commercial building. While some coatings function to provide enhanced features such as non-slip surfacing for garage floors. Most often many types of coatings are placed in a container for use by the individual applying the coating. This will often involve the transfer of the coating from its original container to smaller container that can be easily handled by the user during the painting process. By way of example but not limitation, a roller paint tray is utilized when a coating is being applied with a roller. Liners are available for roller trays wherein the liner can be inserted to receive the paint and then subsequently discarded after painting so as to protect the tray from paint and to be reused without paint residue accumulating on the tray.

Another type of container often utilized especially when applying a coating with a hand brush is a bucket. Sometimes the original gallon can is utilized but more often the paint is transferred to a small bucket like container for storage of the amount needed. One issue with these types of containers is there proclivity to accumulate paint residue and crust. As these paint containers are utilized the paint is most often not cleaned out enough and as such residue will most often be left in the container. This is undesirable for users as the residue can appear in the subsequent container or contaminant the next color if the paint was not dry.

Accordingly, there is a need for a paint container that is configured to be reversible between a first position and a second position wherein each of the positions provides a clean surface and interior volume to receive pain therein.

### SUMMARY OF THE INVENTION

It is the object of the present invention to provide a reusable paint container configured to be reversible between a first position and a second position wherein the paint container of the present invention includes a cylindrical shaped body manufactured from a pliable material such as but not limited to rubber or silicon.

Another object of the present invention is to provide a paint container configured to provide reuse thereof and eliminate prior paint residue wherein the body of the present invention includes an upper perimeter edge manufactured from a rigid material such as but not limited to plastic.

A further object of the present invention is to provide a reusable paint container configured to be reversible between a first position and a second position wherein the body includes an annular shaped wall and wherein the wall includes a first surface and a second surface.

Still another object of the present invention is to provide a paint container configured to provide reuse thereof and eliminate prior paint residue wherein the wall has formed integrally therewith a brush member that extends substantially from the bottom of the body to the upper perimeter edge.

An additional object of the present invention is to provide a reusable paint container configured to be reversible between a first position and a second position wherein in the first position the first surface of the wall is facing the interior volume of the body of the container.

Yet a further object of the present invention is to provide a paint container configured to provide reuse thereof and eliminate prior paint residue wherein in the second position of the body the second surface of the wall is facing the interior volume of the body.

Another object of the present invention is to provide a reusable paint container configured to be reversible between a first position and a second position wherein the brush member is formed in an angular manner and is staggered in formation.

Still an additional object of the present invention is to provide a paint container configured to provide reuse thereof and eliminate prior paint residue wherein body further includes a handle member secured thereto.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the first position of the present invention; and

FIG. 2 is a side perspective view of the present invention; and

FIG. 3 is a perspective view of the second position of the present invention.

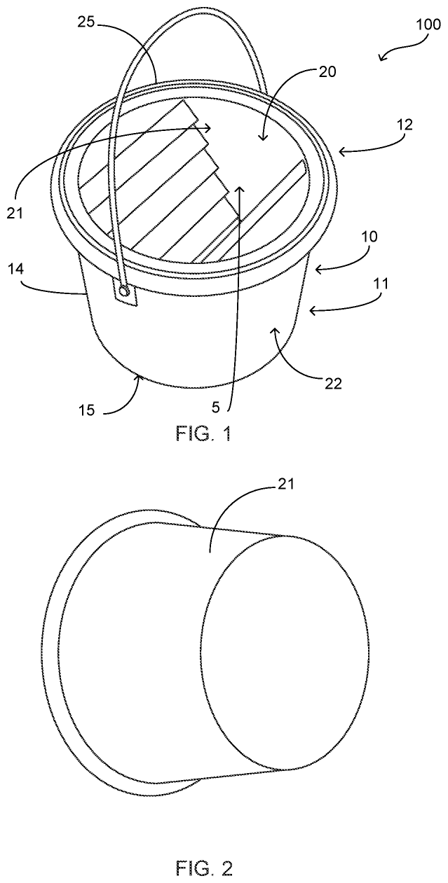

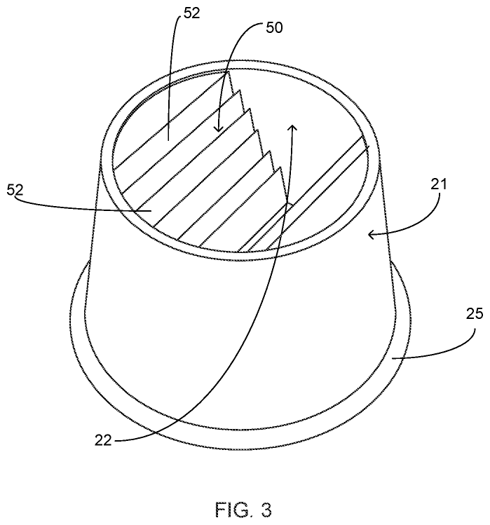

### DETAILED DESCRIPTION

Referring now to the drawings submitted herewith, wherein various elements depicted therein are not necessarily drawn to scale and wherein through the views and figures like elements are referenced with identical reference numerals, there is illustrated a reusable paint container 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular the Figures submitted as a part hereof, the reusable paint container 100 includes a body 10. The body 10 in a preferred embodiment is annular in shape having a bottom end 11 and a top end 12. The body 10 includes a wall 14, which is contiguously formed with the bottom 15 so as to form an interior volume 20. The wall includes a first surface 21 and a second surface 22. It should be understood within the scope of the present invention that the body 10 could be formed in alternate shapes and sizes other than the shape illustrated herein. Proximate the top end 12 and integrally formed therewith is the upper perimeter edge 25. The upper perimeter edge 25 is perpendicular to the wall 14 extending outward therefrom. The upper perimeter edge 25 is manufactured from a durable rigid material such as but not limited to plastic so as to assist in moving the body 10 in between its first position and its second position as will be further discussed herein. It should be understood within the scope of the present invention that the upper perimeter edge 25 could be manufactured from the same material as the body 10.

In a preferred embodiment of the present invention the body 10 is manufactured from a pliable material such as but not limited to silicon or rubber. The body 10 is configured to be moved in between a first position and a second position so as to facilitate the ability to provide an interior volume 20 that is free of paint residue and similar contaminants that are undesirable to have disposed within the interior volume prior to depositing paint or similar coating thereinto. The body 10 construction facilitates the ability to reverse the position thereof so as to quickly provide a clean interior volume. In the first position of the body 10 the first surface 21 is facing the interior volume 20 of the body 10. In this position the reusable paint container 100 is operable to receive a desired coating therein. Upon completion of consumption of the coating disposed within the interior volume 20 of the body 10 in its first position, the user can move the body 10 to its second position. To move the body 10 to its second position, the user will apply a force to the bottom 15 pushing in the direction of the upper perimeter edge 25. The material of the body 10 facilitates the collapsing of the wall 14 and as such the bottom 15 will be pushed through the opening 5 present within the upper perimeter edge 25. This force continues until the bottom 15 is distal to the upper perimeter edge 25 with the wall 14 completely extended. In this second position, the second surface 22 now faces the interior volume 20 of the body 10. The second surface 22 is free of residue and other contaminants and as such as user can deposit a desired coating therein. Additionally, in this position a user can more easily clean the first surface so as to return the body 10 to its first position when desired.

Integrally formed into the wall 14 is the brush member 50. The brush member 50 is manufactured of the same material as the wall 14 and is formed in a staggered formation inclined upwards towards the upper perimeter edge 25. The brush member 50 includes a plurality of ridge members 52 that are operable to allow a user to remove excess coating from a application brush as desired. It should be understood within the scope of the present invention that the brush member 50 could be formed with alternate structures and/or elements and achieve the desired function discussed herein. Additionally, it should be further understood within the scope of the present invention that the body 10 could be provided without the brush member 50 integrally formed into the wall 14.

While a handle member is not particularly illustrated herein it is contemplated within the scope of the present invention that a handle member could be present configured to assist a user in holding the reusable paint container 100 during use or transportation thereof. It should be understood within the scope of the present invention that the handle member could be provided in numerous alternate shapes and sizes. Furthermore, it should be understood within the scope of the present invention that the body 10 could be provided without a handle member.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A container configured to be moved between a first position and a second position wherein the container comprises:
a body, said body having a wall and a bottom integrally formed to create an interior volume, said body having a lower end and an upper end, said body having an opening proximate said upper end, said wall having a first surface and a second surface on opposing sides thereof;
an upper perimeter edge, said upper perimeter edge being proximate said upper end, said upper perimeter edge having a portion extending outward from said wall and being perpendicular thereto; and
wherein in said first position said first surface of said wall is facing said interior volume.

2. The container configured to be moved between a first position and a second position as recited in claim 1, wherein in said second position said second surface of said wall is facing said interior volume.

3. The container configured to be moved between a first position and a second position as recited in claim 2, wherein during transition between said first position and said second position said bottom is pushed through said opening wherein the opening is bordered by the upper perimeter edge.

4. The container configured to be moved between a first position and a second position as recited in claim 3, and further including a brush member, said brush member being disposed within said interior volume, said brush member being integrally formed with said wall of said body.

5. The container configured to be moved between a first position and a second position as recited in claim 4, wherein said wall collapses during transition between said first position to said second position.

6. The container configured to be moved between a first position and a second position as recited in claim 5, wherein said body is manufactured from silicon.

7. A reversible paint container configured to be transitioned between a first position and a second position wherein the reversible paint container comprises:
a body, said body having a bottom and a wall integrally formed to create an interior volume, said body being annular in shape, said body having an upper end and a lower end, said body having an opening at said upper end providing access to said interior volume, said wall of said body having a first surface and a second surface, said body having an upper perimeter edge proximate said upper end, said upper perimeter edge being perpendicular to said wall and extending outward therefrom;
a brush member, said brush member being integrally formed with said wall of said body, said brush member being disposed within the interior volume of said body; and
wherein in said first position said first surface of said wall is facing said interior volume.

8. The reversible paint container configured to be transitioned between a first position and a second position as recited in claim 7, wherein said brush member further includes a plurality of ridge members, said ridge members being laterally oriented within the interior volume of said body.

9. The reversible paint container configured to be transitioned between a first position and a second position as recited in claim 8, wherein in said second position said second surface of said wall is facing said interior volume.

10. The reversible paint container configured to be transitioned between a first position and a second position as recited in claim 9, wherein during transition between said first position and said second position said bottom is pushed through said opening wherein the opening is bordered by the upper perimeter edge.

11. The reversible paint container configured to be transitioned between a first position and a second position as recited in claim 10, wherein said wall collapses during transition between said first position to said second position.

12. The reversible paint container configured to be transitioned between a first position and a second position as recited in claim 11, wherein said body is manufactured from silicon.
